(19) United States
(12) Patent Application Publication
(10) Pub. No.: US 2011/0131813 A1
(43) Pub. Date: Jun. 9, 2011

(54) GRIP STRUCTURE FOR A PAIR OF SCISSORS

(76) Inventor: Chong-Jiang LIN, Taichung County (TW)

(21) Appl. No.: 12/897,676

(22) Filed: Oct. 4, 2010

(30) Foreign Application Priority Data
Dec. 8, 2009 (TW) 098141915

(51) Int. Cl. B26B 13/00

(52) U.S. Cl. 30/232

(57) ABSTRACT

A grip structure for a pair of scissors is disclosed. The pair of scissors is provided with a first grip portion to be engaged between the first joint and the joint at the base of the thumb of the user. The first grip portion is centrally formed with a inserting hole for insertion of the first joint of the thumb. The first grip portion is further formed with a concave portion which makes room for the first joint of the thumb when the thumb is inserted in the inserting hole of the first grip portion, ensuring the first grip portion to be located on the first segment bone adjacent to the first joint.

### BACKGROUND OF THE INVENTION

1. Field of the Invention

The present invention relates to a pair of scissors, and more particularly to grip structure for a pair of scissors.

2. Description of the Prior Art

A first pair of conventional scissors 10, as shown in FIGS. 1-2, comprises two blades 11, 12 that are pivotally connected at a pivot, and two handles 13, 14 that are connected to the respective blades 11, 12 adjacent to the pivot of the two blades 11, 12. The respective handles 13, 14 are provided with a ring-shaped grip portion 15, 16. The first grip portion 15 is provided for insertion of the thumb 21 of a user's hand 20 to push the first blade 11 to rotate, while other fingers of the hand 20 insert in the second grip portion 16 to rotate the second blade 12 through the second handle 14.

The thumb 21 of the hand 20 includes, from a basal joint 211 of a base 210 of the thumb 21, a first segment bone 212, a first joint 213 and a second segment bone 214. When the tip end of the thumb 21 inserts in the first grip portion 15, the first grip portion 15 will be located on the second segment bone 214, and the closing and opening of the scissors 20 are normally achieved by the relative motion of the thumb 21 and other four fingers around the basal joint 211 of the thumb 21. In order to make the two blades 11, 12 of the scissors 10 move away from each other from the closed position to carry out an opening operation, the thumb 21 should gradually move away from other four fingers, however, when using scissors, most users' habit is to move the thumb 21 and other four fingers without moving the wrist. Just as shown in FIG. 2, the first segment bone 212 of the thumb 21 moves an angle α around the basal joint 211 from its original position, causing the scissors 10 to deflect a deflection angle β from its original vertical position, meanwhile, the second segment bone 214 is caused to deflect a deflection angle σ around the first joint 213, so that the total deflection angle of the scissors 10 is the sum of the deflection angles β and σ, thus causing the undesired movement of the blades 11, 12 during the cutting operation. As a result, it can be found that the cutting quality is difficult to control due to the undesired movement of the scissors, which is likely to further endanger the other hand holding the object to be cut.

Furthermore, referring to FIG. 3 which illustrates a second pair of conventional scissors, the grip portions 15, 16 are designed to abut more closely against the palm. The grip portion 15 is formed with a tapered through hole to better fit the thumb 20. However, the grip portion 15 is still located on the second segment bone 214, so the drawback of undesired movement of the scissors shown in FIG. 2 still exists.

Since the respective grip portions 15 of the above scissors 10 are engaged on the second segment bone 214 of the thumb 21, the undesired movement is likely to occur during the operation of the scissors 10. In addition, since the grip portions 15, 16, the handles 13, 14 and the blades 11, 12 are located on the same plane, it is difficult for the user to directly insert the thumb and other four fingers of one hand in the grip portions 15, 16 when the scissors 10 is placed on a table and the user needs to pick it up, so the user has to pick the scissors 10 up from the table with one hand and then the other hand is able to insert in the grip portions 15, 16, leading to inconvenience in use.

The present invention has arisen to mitigate and/or obviate the afore-described disadvantages.

### SUMMARY OF THE INVENTION

The primary objective of the present invention is to provide a grip structure for a pair of scissors, a grip portion of the grip structure of the present invention is formed with an inserting hole for insertion of the thumb of the hand, and the inserting hole is formed with two inserting ends in such a manner the second inserting end tapers toward the first inserting end, and the grip portion is further formed with an concave portion which makes room for the first joint, so that the grip portion can be closely abutted against the thumb, thus making the grip portion kept in the most stable state during the closing or opening of the scissors. Therefore, the undesired deflection of the two blades of the scissors can be avoided, and the two blades are kept in the best vertical state during the cutting process, effectively improving the cutting quality and safety.

### BRIEF DESCRIPTION OF THE DRAWINGS

FIG. 1 is a schematic view of a first pair of conventional scissors gripped by the hand;

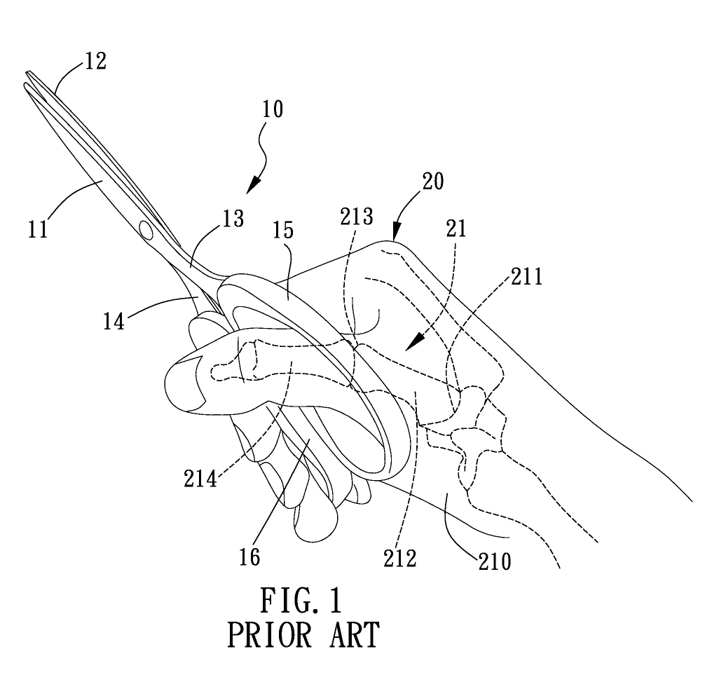

FIG. 2 is a skeleton view of the thumb of the hand gripping the scissors of FIG. 1;

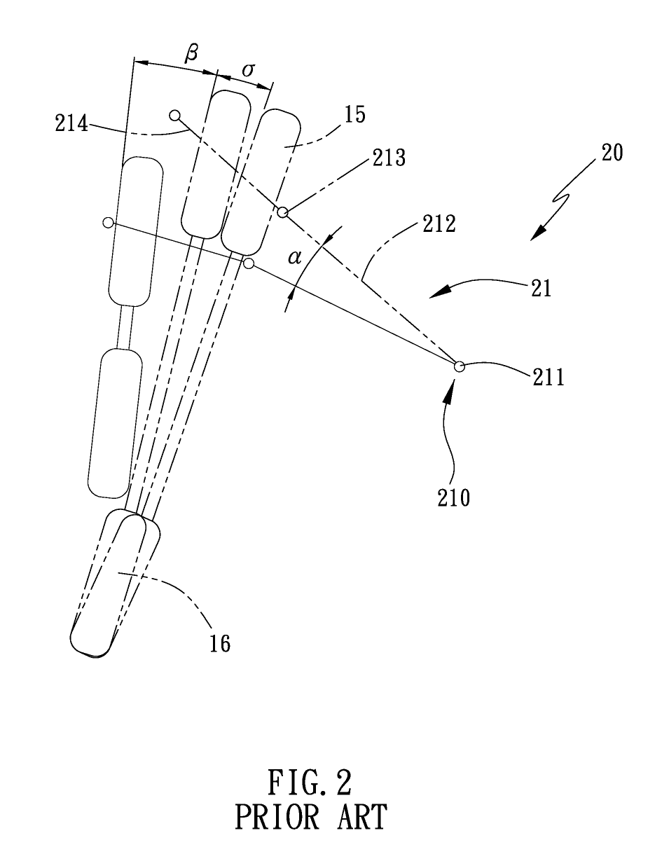

FIG. 3 is a schematic view of a second pair of conventional scissors gripped by the hand;

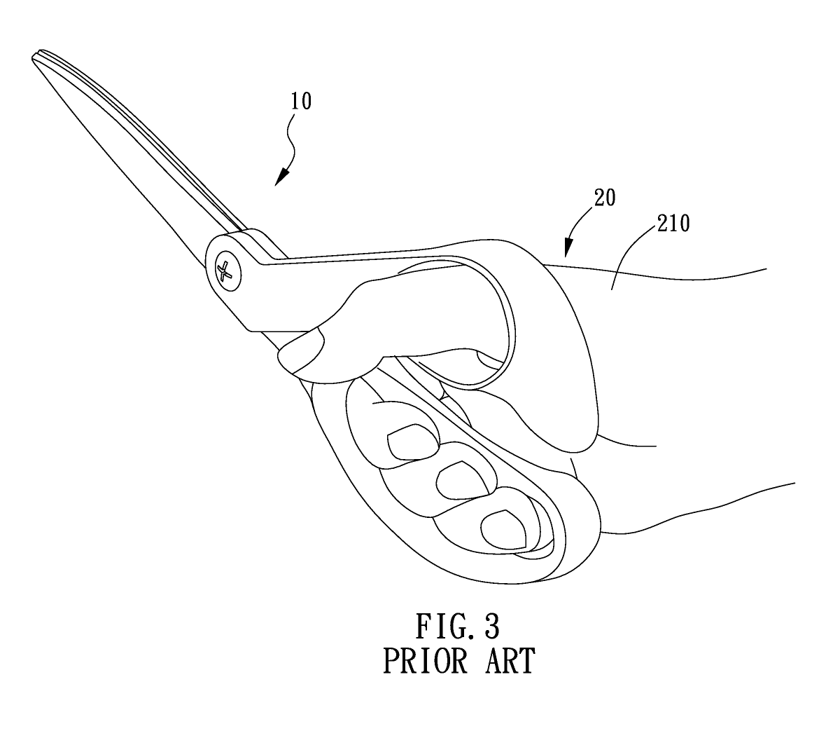

FIG. 4 is a perspective view of a grip structure for a pair of scissors in accordance with the present invention;

FIG. 5 is a skeleton view of the hand gripping the scissors in accordance with the present invention;

FIG. 6 is a side view of the opening scissors, showing the first grip portion in accordance with the present invention;

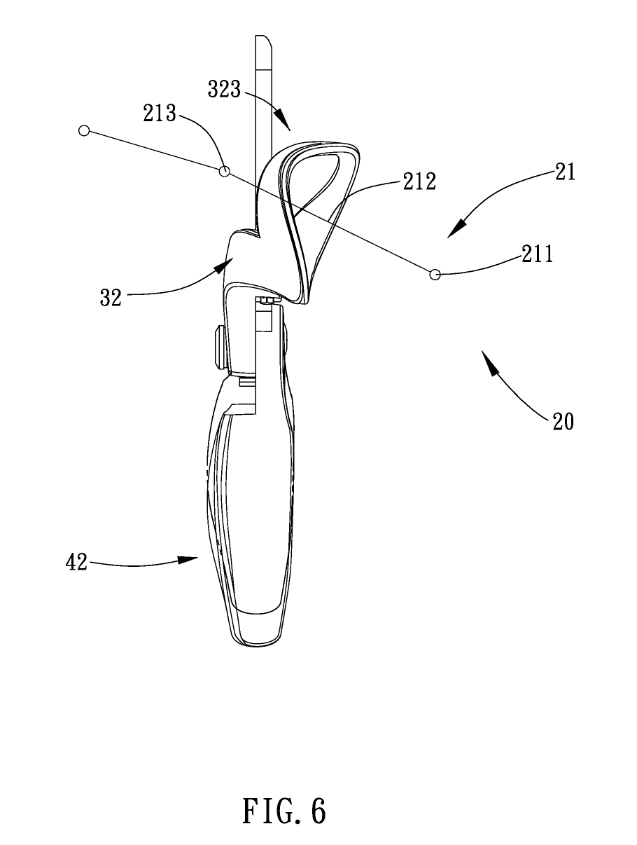

FIG. 7 is a side view showing the operation of the scissors in accordance with the present invention; and

FIG. 8 is a schematic view showing how the user picks up the scissors in accordance with the present invention with one hand.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

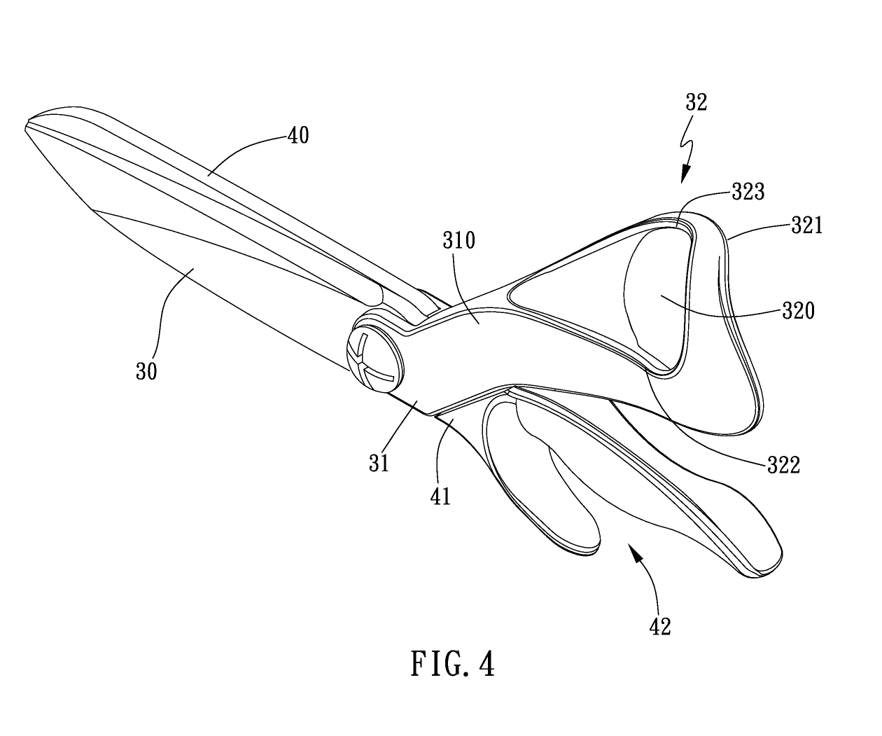

Referring to FIG. 4, a grip structure for a pair of scissors in accordance with a preferred embodiment of the present invention comprises a first blade 30 and a second blade 40 that can open/close with respect to each other. The first blade 30 and the second blade 40 are connected to first ends of a first and a second handles 31, 41 that are pivoted to each other. The two handles 31, 41 are provided at their second ends with a first grip portion 32 and a second grip portion 42. The first grip portion 32 is configured to fit the base 210 of the thumb 21 of the hand 20.

The first handle 31 is formed with a curved abutting portion 310 extending toward the first grip portion 32 and formed correspondingly to the contour of the center of the palm of the hand 20 so that the first grip portion 32 can be really closely abutted against the palm center of the user. The first grip portion 32 is centrally formed with an inserting hole 320 for insertion of the thumb 21 of the hand 20, so that the first grip portion 32 and the inserting hole 320 can be closely abutted against the base of the thumb 21.

The inserting hole 320 of the first grip portion 32 is an elongated arc hole and formed with a first inserting end 321 and a second inserting end 322 in such a manner that the second inserting end 322 tapers toward the first inserting end 321, and the user's thumb inserts the inserting end 321 and out of the second inserting end 322. As shown in FIG. 4, the first grip portion 32 is further formed with an arc-shaped concave portion 323 which makes room for the first joint 213 of the thumb 21. when being inserted in the inserting hole 320 of the first grip portion 32, the first joint 213 of the thumb 21 will be located outside the range of the arc-shaped concave portion 323, in other words, when the inserting hole 320 of the first grip portion 32 is engaged on the base 210 of the thumb 21, the first grip portion 32 will be engaged on the first segment bone 212, and the arc-shaped concave portion 323 makes room for the greatest-magnitude-of-motion end of the first segment bone 212, namely, the first joint 213, making the first grip portion 32 engaged between the first joint 213 and the base 210. Since the base 210 of the thumb 21 almost never moves during the cutting process, the scissors in accordance with the present invention can be operated with high stability.

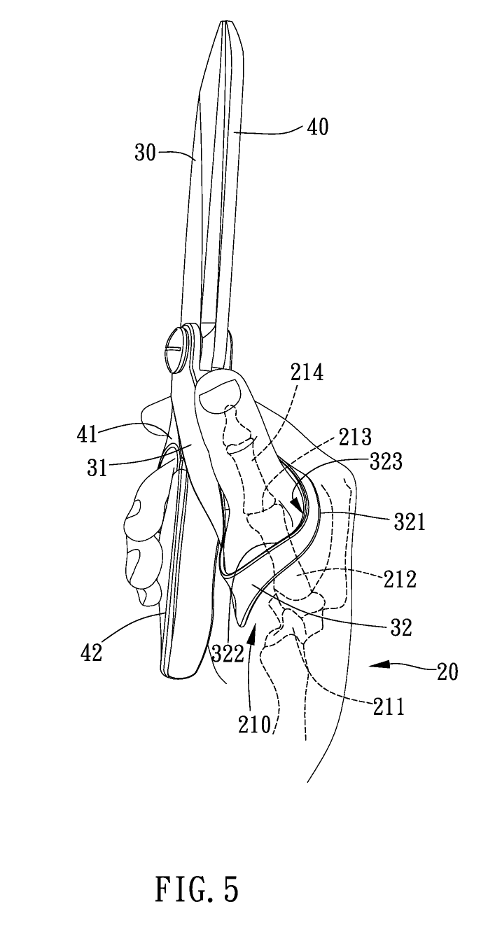

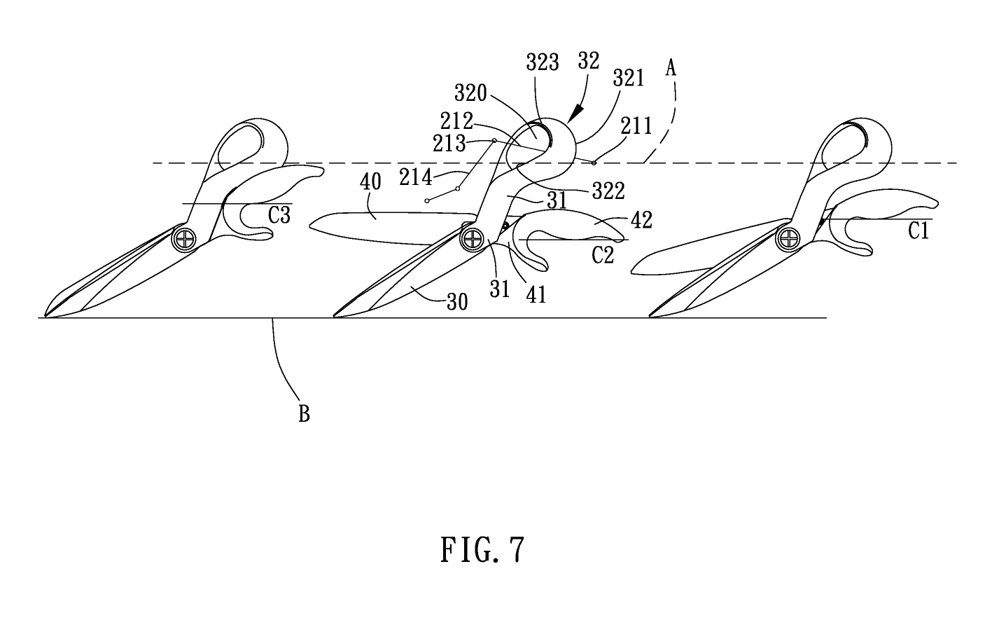

Referring to FIG. 5, since the bottom of the first grip portion 32 is located adjacent to the center of the palm of the hand 20, and the top of the first grip portion 32 is provided with the arc-shaped concave portion 323 which makes room for the first joint 213 of the thumb 21, the first grip portion 32 can be surely engaged on the base 210 of the thumb 21. When the user is cutting with the scissors in accordance with the present invention along the horizontal direction A with the hand 20, as shown in FIG. 7, the first segment bone 212 and the first grip portion 32 are kept at a constant height while moving along the horizontal direction A, and the first blade 30 is moved forward with its tip end abutting against a plane B, so that the first grip portion 32 and relative structures is ensured to keep moving horizontally without undesired deflection and swing, and the first blade 30 is maintained at an optimal vertical direction relative to the plane B. Meanwhile, the user's other four fingers of the hand 20 are inserted in the second grip portion 42 to make the second grip portion 42 move at a first height C1, a second height C2 and a third height C3, respectively, in other words, the motion of the second grip portion 42 at different heights causes opening and closing of the second blade 40 and the first blade 30 relative to each other. By such arrangements, as shown in FIG. 5, the scissors in accordance with the present invention is quite stable during the cutting operation since the two blades 30, 40 can synchronously perform cutting operation in the direction vertical to the plane B.

The grip structure for a pair of scissors in accordance with the present invention has the following advantages:

1. High stability: the first grip portion 32 is fully engaged on the first segment bone 212 of the thumb 21 adjacent to the center of the palm, so that as long as the hand 20 keeps stable, the first blade 30 connected to the first grip portion 32 will perform the cutting operation with high stability.

2. Better cutting direction control and high safety: since the first grip portion 32 is engaged on the base of the thumb 21, the cutting stability is high without undesired deflection, the tip ends of the two blades 30, 40 are effectively controlled in direction, avoiding endangering the other hand holding the object to be cut, enhancing the safety of the scissors.

3. Substantially enhanced cutting quality: due to the high stability and controllability between the first grip portion 32 and the hand 20, the occurrence of undesired deflection and swing is reduced, and when being cutting the object, the two blades 30, 40 can be maintained in the optimal vertical direction, realizing the best cutting quality.

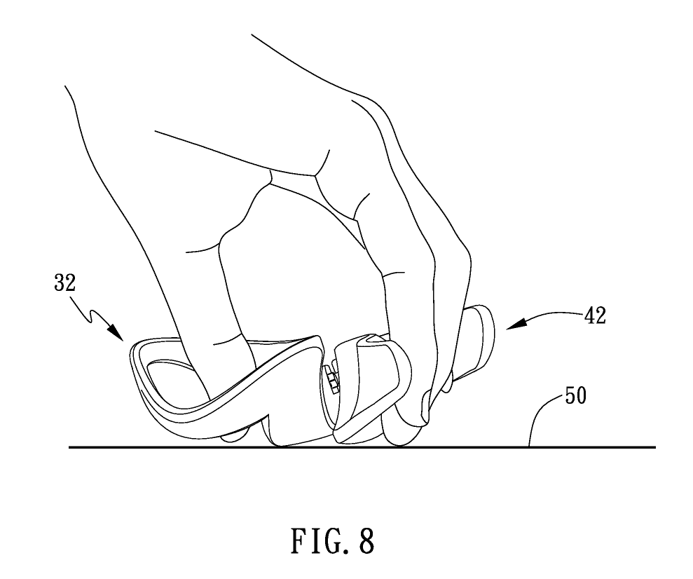

4. Convenient to pick up: the curved abutting portion 310 formed on the handle 31 of the scissors 10 makes the first grip portion 32 oblique with respect to the blade 30, so that when the scissors 10 are placed on the desk, the first grip portion 32 is kept away from the desk, as shown in FIG. 8, for facilitating the insertion of the finger of the user without the help of the other hand, thus improving the convenience in use.

While we have shown and described various embodiments in accordance with the present invention, it is clear to those skilled in the art that further embodiments may be made without departing from the scope of the present invention.

What is claimed is:

1. A grip structure for a pair of scissors comprising:
two blades; and
two handles each having a first end on which the respective blades are fixed, the first ends of the two handles being pivoted each other, one of the two handles being formed with a first grip portion for insertion of a thumb of a hand, and the other of the two handles being formed with a second grip portion for insertion of other four fingers of the hand, the thumb including, in order from a basal joint of a base thereof, a first segment bone, a first joint and a second segment bone, the first grip portion being centrally formed with an inserting hole to be engaged on the first segment bone of the thumb, and the inserting hole of the first grip portion being formed with concave portion, when being inserted in the inserting hole of the first grip portion, the first joint of the thumb will be located outside the range of the concave portion.

2. The grip structure for a pair of scissors as claimed in claim 1, wherein the first grip portion is configured to fit the base of the thumb of the hand.

3. The grip structure for a pair of scissors as claimed in claim 2, wherein the handle which is provided with the first grip portion is further formed with an abutting portion so that the first grip portion is really closely abutted against a palm center of the hand.

4. The grip structure for a pair of scissors as claimed in claim 2, wherein the inserting hole of the first grip portion is an elongated arc hole, the concave portion of the first grip portion is arc-shaped, the inserting hole of the first grip portion is engaged on the base of the thumb, the first grip portion is engaged on the first segment bone, and the concave portion makes room for the first joint.
